(19) United States
(12) Patent Application Publication
(10) Pub. No.: US 2005/0277380 A1
(43) Pub. Date: Dec. 15, 2005

(54) Recreational vehicle holding tank exhaust fan. Removes all odor from holding tank. Makes camping much more pleasant

(76) Inventor: Joseph W. Horner, Browns Mills, NJ (US)

Correspondence Address: JOSEPH W. HORNER, 4 WASP ST., BROWNS MILLS, NJ, 08015, US

(21) Appl. No.: 10/253,269

(22) Filed: Dec. 18, 2002

(51) Int. Cl. B60H 1/00; B60H 1/26

(52) U.S. Cl. 454/136

(57) ABSTRACT

The Recreational Vehicle Exhaust Fan I have invented makes camping more enjoyable and safer. It removes 100% waste odors and harmful gasses. I have never seen anything like it in use or for sale anywhere. Before my fan, campers just had to suffer with the problem.

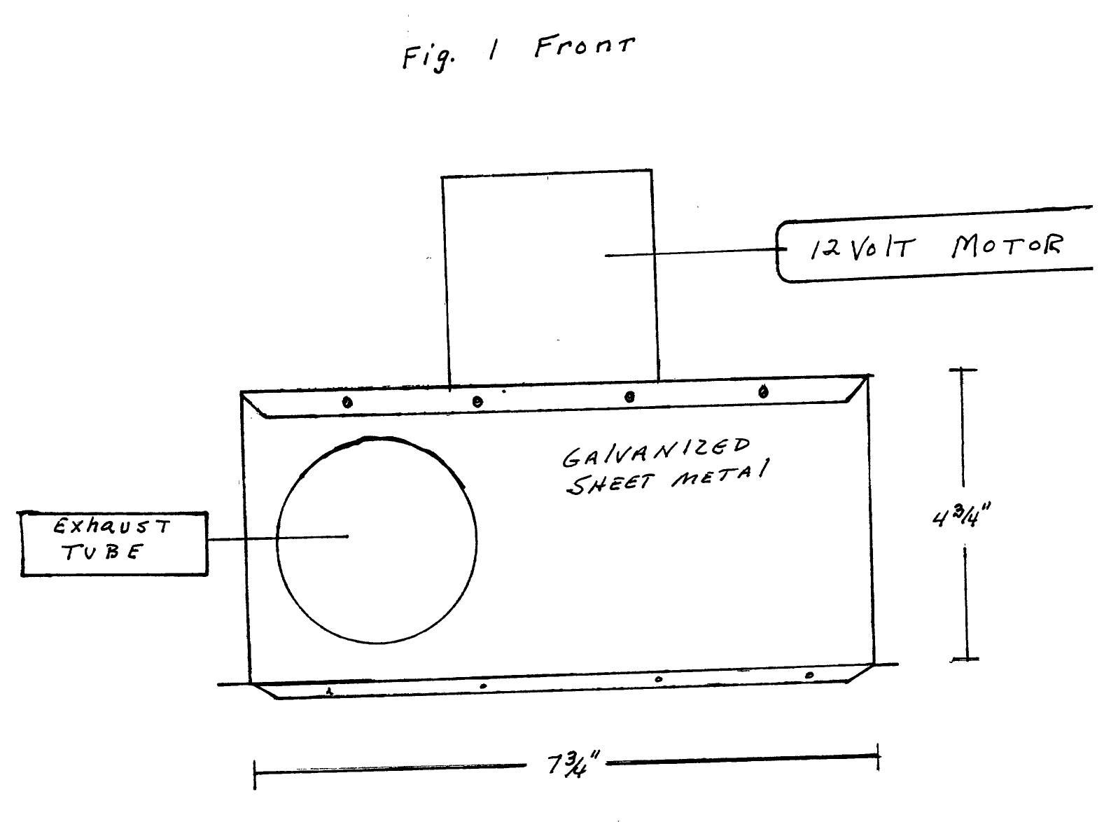

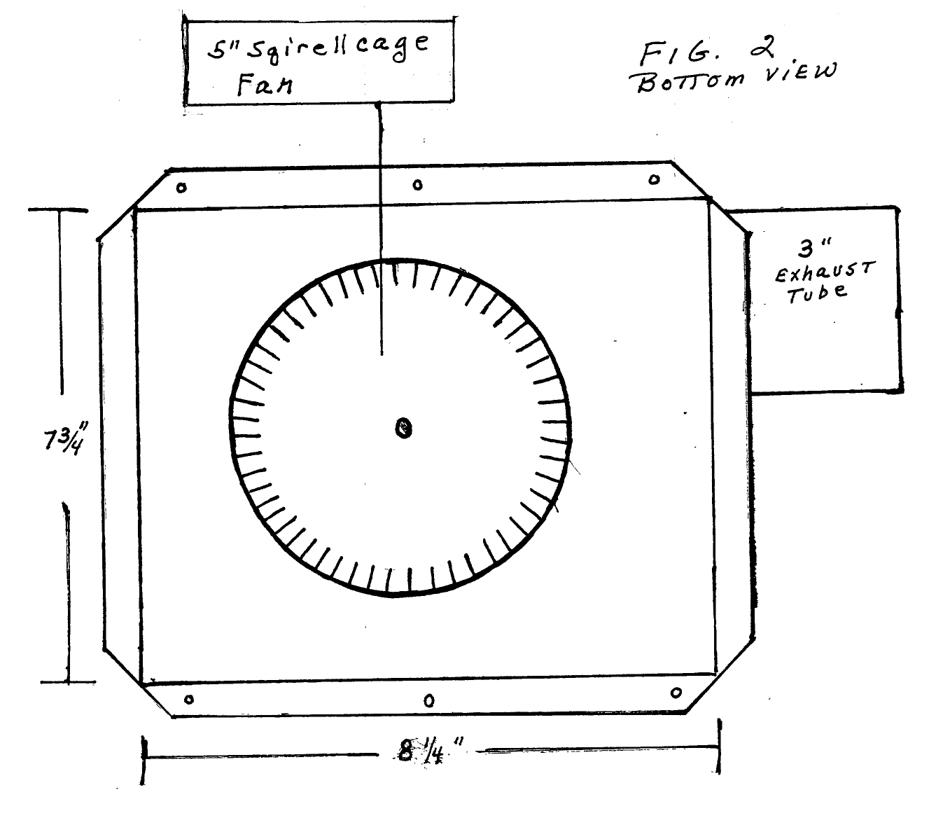

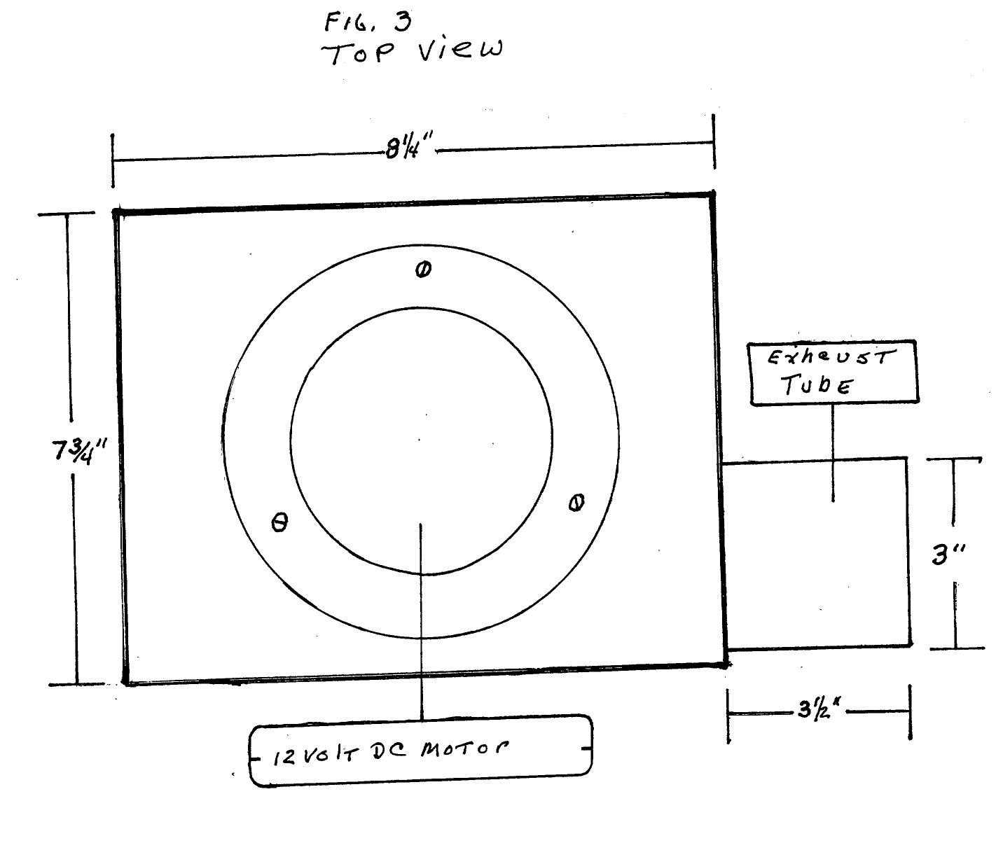

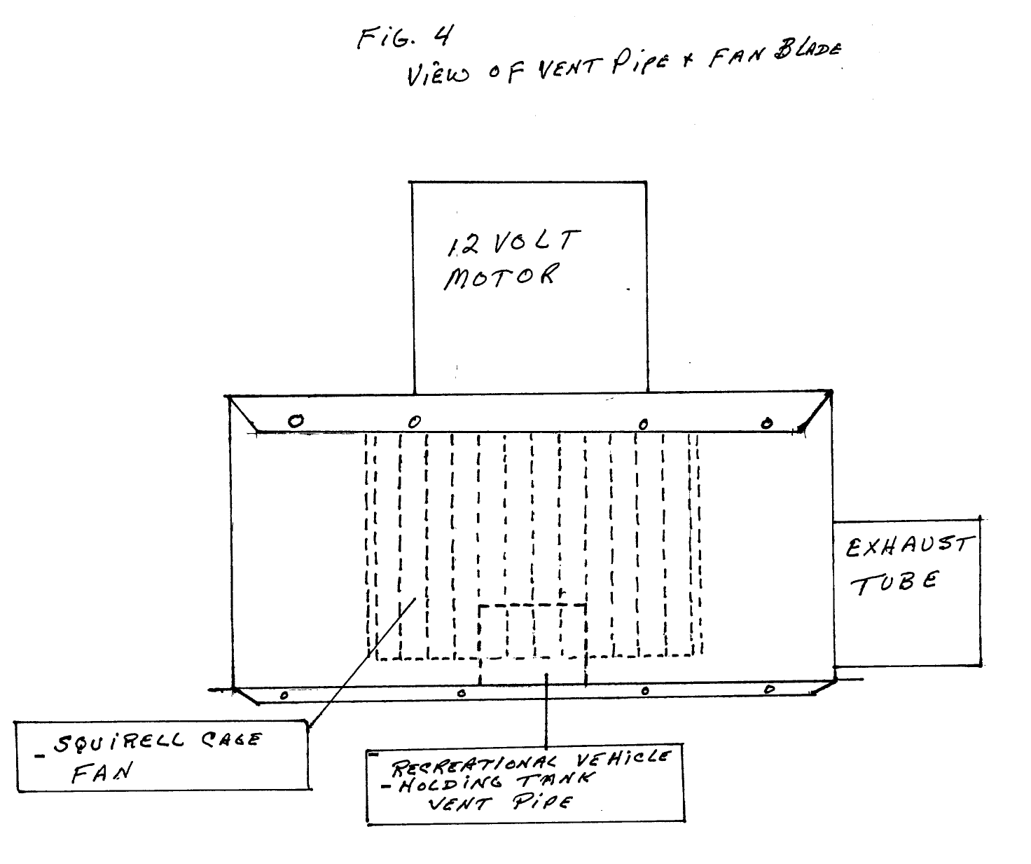

The Recreational Vehicle Holding Tank Exhaust Fan is a sheet metal box 7¾″ by 8¼″ square and 4¾″ deep. A 3″ exhaust tube on one side and a 6″ round opening in the top to accommodate a 12 volt Squirell Cage Fan.

### BACKGROUND OF INVENTION

Recreational vehicles parked in a campground without the benefit of a sewer hookup use the holding tank to contain waste for several days at at a time. In hot humid weather the odor becomes unbearable. With my Recreational Vehicle Holding Tank Exhaust Fan installed on the roof over the holding tank vent pipe, it removes 100% of the fumes and gasses.

### SUMMARY

The Recreational Vehicle Holding Tank Exhaust Fan solves the problem of sewer gasses and odor in a Recreational Vehicle parked in a campground without the benefit of a sewer hookup. It makes camping a lot more enjoyable and healthy.

1. I claim my invention removes 100% of odors and gasses from human waste in a Recreational Vehicle holding tank. After many years of camping I have never seen fan for this purpose on a vehicle or for sale at a dealership.
